(19) United States
(12) Patent Application Publication
(10) Pub. No.: US 2013/0259253 A1
(43) Pub. Date: Oct. 3, 2013

(54) CONTROLLERS FOR ACTIVE NOISE CONTROL SYSTEMS

(71) Applicants: Rogerio Guedes Alves, Macomb Township, MI (US); Walter Zuluaga, Rochester Hills, MI (US)

(72) Inventors: Rogerio Guedes Alves, Macomb Township, MI (US); Walter Zuluaga, Rochester Hills, MI (US)

(21) Appl. No.: 13/434,350

(22) Filed: Mar. 29, 2012

(51) Int. Cl. G10K 11/16

(52) U.S. Cl. 381/71.12

(57) ABSTRACT

A method for obtaining coefficients for a non-adaptive controller for use in an active noise control system, the method comprising capturing experimental data from a target system to characterise the plant of the target system; and implementing an adaptive algorithm to compute the coefficients in dependence on the experimental data.

### FIELD OF THE DISCLOSURE

The present invention relates to obtaining non-adaptive controllers for use in an active noise control (ANC) system.

### BACKGROUND

Acoustic noise is prevalent throughout everyday life, from industrial equipment through to the engine noise in an aeroplane. Traditional methods of ambient noise control have focussed on passive attenuation; physical enclosures such as barriers and walls are used to combat the unwanted noise. However such methods can be impractical and expensive to implement.

Active noise control (ANC) is based on the principle of superposition. An anti-noise wave of equal amplitude and opposite phase to the unwanted noise is generated and destructively interferes with the ambient noise, at least partly cancelling it out. A simple circuit implementing this technique is shown in FIG. 1. A microphone 101 measures the residual noise Nᵣ(t). This is converted by the microphone into a signal e(t) which is fed into a controller 102 which uses coefficients c(t) to output a signal u(t) to be fed into a loudspeaker 103, the loudspeaker then generating the corresponding anti-noise to at least partially cancel out the unwanted noise. The residual noise Nᵣ(t) measured by the microphone 101 is formed from the superposition of the unwanted disturbance noise Nᵢ(t) and the noise N_{c}(t) generated by the loudspeaker.

The circuit in FIG. 1 can be equally represented as a block diagram as shown in FIG. 2, the characterisation of which is known in control theory as the disturbance rejection problem. Control problems are often analysed in the Laplace domain s due to the simple relationship between input and output signals of a system, u(s) and y(s) respectively, given by:

y(s)=H(s)u(s)

Here H(s) is known as the transfer function, and is given by the Laplace transform of the impulse response of a system.

In FIG. 2 a signal u(t) is output from a controller 201 and input into a plant 202. The output of the plant 202 is summed with a disturbance signal d(t) at a summing junction 203 to produce an error signal e(t). The error signal forms the input to the controller.

Referring to FIG. 2, \tilde{C}(s) represents the transfer function of the controller in the Laplace domain. The input and output signals of the controller are thus related in the Laplace domain by the relationship:

u(s)=\tilde{C}(s)e(s)

Here u(s) is the Laplace transform of the signal u(t) and e(s) is the Laplace transform of the signal e(t).

In control theory the “plant” is a term often used to describe the physical system under control. In an ANC system the plant may be some or all of the system from the input of the loudspeaker, or any amplifier or other circuitry that drives the loudspeaker, to the output signal of the microphone used to measure the residual noise. The transfer function of the plant in the Laplace domain is denoted by \tilde{P}(s). In the absence of noise control (i.e. the absence of a controller), the microphone will record the ambient disturbance noise Nᵢ(t). The output signal of the microphone in the absence of noise control is termed the disturbance signal dᵢ(t). The error signal e(t) is the output signal of the microphone. In the absence of noise control the error signal e(t) will be equal to the disturbance signal dᵢ(t). If noise control is being employed, the microphone will record the residual noise formed from the superposition of the disturbance noise Nᵢ(t) and the output of the loudspeaker N_{c}(t). This residual noise will be converted by the microphone into the error signal e(t).

It is important to notice the conceptual difference between depicting an ANC problem by a physical circuit diagram or by a block diagram representation. In a practical implementation of a circuit employing active noise control, for example FIG. 1, a microphone will measure the residual noise formed from the superposition of the ambient disturbance noise Nᵢ(t) and the output of the loudspeaker N_{c}(t). This noise cancellation takes place in a physical medium. The resultant noise is then recorded by the microphone and converted into an error signal e(t). In the block diagram representation of the ANC problem, for example in FIG. 2, the output signal of the plant is summed with the disturbance signal to produce the error signal. Here the superposition is of generic signals, not necessarily of sound waves in a physical medium. As mentioned, the disturbance signal dᵢ(t) is the signal the microphone would output if it recorded only the disturbance noise Nᵢ(t). Hence in a physical system that is currently employing ANC, the disturbance signal dᵢ(t) cannot be recorded independently because the microphone does not record the disturbance noise Nᵢ(t), but rather the residual noise. The output signal of the plant in a block diagram representation is the signal that would be output from a microphone that recorded only the noise generated by the loudspeaker. This signal is then summed with the signal that would be output from a microphone that recorded only the disturbance noise. Notice that despite these differences in interpretation, the error signal formed in each representation is identical.

Analysing FIG. 2 in the Laplace domain we see that u(s)\tilde{P}(s)+d(s)=e(s), but also that u(s)=−e(s)\tilde{C}(s), which can be re-arranged to give:

$$\frac{e ( s )}{d ( s )} = \frac{1}{1 + \tilde{P} ( s ) \tilde{C} ( s )}$$

Here d(s) is the Laplace transform of the signal d(t). The above example illustrates that if the system to be controlled can be well modelled so that \tilde{P}(s) is well known, the transfer function, \tilde{C}(s), of the controller of the system can be designed to minimise the error of the system.

In the past the ANC problem was solved using analogue controllers; however the development of digital signal processor (DSP) chips in the 1980s enabled the development of digital controllers. Along with this came the development of adaptive controllers. Typically the impulse response of a controller is determined by a number of coefficients, termed “controller coefficients”. The values of the controller coefficients determine the value of its transfer function. An adaptive controller adjusts the value of its coefficients to alter the relationship between a given input and output signal in response, for example, to alterations to the noise source or the environment.

For a digital controller, an output signal at time k, y(k), can be expressed in terms of past and present input signals and past output signals:

$$y ( k ) = {\sum }_{i = 0}^{N} {b}_{i} x ( k - i ) - {\sum }_{j = 1}^{M} {a}_{j} y ( k - j ) \qquad ( 1 )$$

Here the past and present input signals are denoted by x(k−i), the past output signals are denoted by y(k−j), and bᵢ and aⱼ are weighting coefficients.

In an example of a finite impulse response controller, the coefficients aⱼ=0:

$$y ( k ) = {\sum }_{i = 0}^{N} {b}_{i} x ( k - i ) \qquad ( 2 )$$

The above equation can be transformed to the z-domain by means of a z-transform. A z-transform can be considered to be the discrete time equivalent of the Laplace transform, and so the z domain rather than the Laplace domain is the appropriate transfer domain for digital controllers. Taking the z-transform of both sides and using the fact that the z-transform is a linear operation gives:

$$Z [ y ( k ) ] = {\sum }_{i = 0}^{N} {b}_{i} Z [ x ( k - i ) ] \qquad ( 3 )$$

The z-transform of y(k) is denoted by Y(z). Similarly the z-transform of x(k) is denoted by X(z). The shift theorem states that Z[x(k−i)]=z⁻ⁱZ[x(k)]=z⁻ⁱX(z). Therefore equation 3 can be re-written as:

$$Y ( z ) = {\sum }_{i = 0}^{N} {b}_{i} {z}^{- i} X ( z ) \qquad ( 4 )$$

This gives an expression for the transfer function T(z) as:

$$T ( z ) ≡ \frac{Y ( z )}{X ( z )} = {\sum }_{i = 0}^{N} {b}_{i} {z}^{- i} \qquad ( 5 )$$

Thus the same coefficients bᵢ can be used to calculate the transfer function of a system as well as computing a time domain output signal in terms of a time domain input signal. This means if the coefficients are known, the output signal of a system can be calculated in the z-domain or the time domain.

FIG. 2 is an example of a non-adaptive analogue feedback controller. An example of an adaptive digital feedback controller is shown in FIG. 3. To clarify that a discrete digital controller is being used, the time is given by the variable k. In an analogue system the Laplace variable and time are given by s and t respectively, in a digital system the discrete Laplace variable and time are given by z and k, respectively.

The output of an adaptive controller 301 subject to an input signal x(k) is the signal u(k). The signal u(k) is an input signal to a plant 302 with corresponding transfer function \tilde{P}(z) and a plant estimate 303 with corresponding transfer function P̅(z). The output signal of the plant 302 and the disturbance signal dᵢ(k) are summed at a first summing junction 304 to produce an error signal e(k). The error signal is input into a Least Mean Squares (LMS) algorithm module 305 and a second summing junction 306. At the second summing junction 306 the error signal e(k) and the output signal from the plant estimate 303 are summed to produce x(k), an estimate of the disturbance signal dᵢ(k). The signal x(k) is input into the LMS algorithm module 305 and the controller 301. The LMS algorithm module 305 calculates new values of the coefficients of the controller 301 and inputs these new values to the controller via the signal path 307.

If the coefficients used in the plant model are approximately equal to the coefficients of the plant then the reference signal x(k) will be approximately equal to the disturbance signal dᵢ(k), and so this circuit utilises the disturbance signal for feedback rather than the generated error signal e(k). A problem with the circuit in FIG. 3 is that it will generally be unstable because the error signal will not be correctly synchronised with the reference signal. This is because the plant estimate introduces a delay to the signal from the controller to the summing junction. One solution to deal with this problem is to place a plant with a transfer function equal to 1/ P̅(z) in series with the plant estimate 303. However the transfer function of a plant is not guaranteed have an inverse. The favoured solution therefore is to place an identical estimate of the plant (which hence has the same transfer function P̅(z)) in the reference signal path to the LMS algorithm. This leads to the well-known Filtered-Reference Least Mean Square (FXLMS) algorithm, and a feedback controller using this algorithm is shown in FIG. 4.

In FIG. 4 an adaptive controller 401 has an input reference signal x(k) and an output signal u(k). The output signal is input into a plant 402 with corresponding transfer function \tilde{P}(z) and a first plant estimate 403 with corresponding transfer function P̅(z). The output signal of the plant 402 is summed at a first summing junction 404 with the disturbance signal dᵢ(k). This produces an error signal e(k) which is input into an LMS algorithm module 405 and a second summing junction 406. At the second summing junction 406 the error signal e(k) and the output of the first plant estimate 403 are summed to produce a reference signal x(k), which is an approximation of the disturbance signal dᵢ(k). The reference signal x(k) is input into a second plant estimate 407 and the adaptive controller 401. The second plant estimate 407 has a corresponding transfer function P̅(z), equal to the transfer function of the first plant estimate 403. The output of the second plant estimate 407 is a filtered reference signal \hat{x}(k), which is input into the LMS algorithm module 405. The LMS algorithm module 405 calculates new values of the controller coefficients and inputs these into the controller 401 via signal path 408.

The objective of characterising an adaptive controller is to find values of its coefficients such that an appropriate error signal is reduced, and ideally minimized.

The FXLMS algorithm is an appropriate algorithm to calculate these coefficients. The equation for the error is given by:

e(k)=dᵢ(k)+P^{T}(k)·U(k) (6)

Where P(k) and U(k) are column vectors with length M, and given by:

P(k)=[p₁(k)p₂(k) . . . p_{M}(k)]^{T} (7)

p₁(k), p₂(k) etc. are the coefficients of the plant.

U(k)=[u₁(k)u₂(k−1) . . . u_{M}(k−M+1)]^{T} (8)

The equation for updating the coefficients of the adaptive controller is:

C(k+1)=C(k)−μ\hat{X}(k)·e(k) (9)

Here μ is the step size of the algorithm and C(k) and \hat{X}(k) are column vectors given by:

C(k)=[c₁(k)c₂(k) . . . c_{N}(k)]^{T} (10)

\hat{X}(k)=[\hat{x}(k)\hat{x}(k−1) . . . \hat{x}(k−N+1)]^{T} (11)

C(k) is a vector of coefficients and cᵢ(k), c₂(k) etc. are the controller coefficients in the time domain. N represents the number of coefficients of C(k). u(k), x(k) and \hat{x}(k) are given by:

u(k)=X^{T}(k)·U(k) (12)

x(k)=e(k)+\hat{P}^{T}(k)·U(k) (13)

\hat{x}(k)=\hat{P}^{T}(k)·X(k) (14)

X(k) is a column vector given by:

X(k)=[x(k)x(k−1) . . . x(k−N+1)]^{T} (15)

The algorithm is often simplified by assuming that the plant estimate is exact, however the plant estimate can be estimated by another adaptive filter.

Both a controller and a plant receive an input signal and produce an output signal. The output signal of a controller can be expressed, for example, by the equation:

$$y ( k ) = {\sum }_{n = 0}^{N - 1} {c}_{n} ( k ) x ( k - n ) \qquad ( 16 )$$

where cₙ(k), n=0, 1, . . . N−1 are the coefficients of the controller at time k and N is the number of coefficients of the controller.

The output signal of a plant can be expressed, for example, by the equation:

$${y}_{p} ( k ) = {\sum }_{n = 0}^{M - 1} {p}_{n} ( k ) x ( k - n ) \qquad ( 17 )$$

Thus the controller may be pre-programmed to output a signal y(k) in dependence on an input signal x(k−n) and coefficients cₙ(k). A plant may be pre-programmed to output a signal yₚ(k) in dependence on an input signal x(k−n) and coefficients pₙ(k).

A controller can also be implemented in a feedforward ANC system. A typical circuit utilising feedforward ANC uses two microphones, one microphone is external to the ANC system and the other is internal. The external microphone records the residual noise external to the ANC system and the internal microphone records the residual noise internal to the ANC system. The residual noise is formed from the superposition of the disturbance noise and noise produced by the loudspeaker. In this implementation the reference signal is given by the external microphone signal, rather than by the estimate of the disturbance signal as in the feedback controller.

FIG. 5 shows a block diagram of an adaptive feedforward controller. In the feedforward system of FIG. 5 a disturbance signal dₑ(k) is output by a first microphone 501 which is external to the ANC system. The microphone measures the residual noise external to the ANC system. The disturbance signal dₑ(k) is input directly into an adaptive controller 502. In this case the reference signal x(k) is the disturbance signal dₑ(k). The output of the adaptive controller 502 is the signal u(k), which is input into a plant 503 with corresponding transfer function \tilde{P}(z). The output signal of the plant 503 is input into a summing junction 504. A second disturbance signal dᵢ(k) and the output of the plant 503 are summed at the summing junction 504 to produce an error signal e(k). The disturbance signal dᵢ(k) is equal to the output of a microphone that recorded only the disturbance noise internal to the ANC system. The error signal is input into an LMS algorithm module 505. The reference signal x(k) is also input into a plant estimate 506 with corresponding transfer function P̅(z). The output of the plant estimate 506 is a filtered reference signal \hat{x}(k), which is input into the LMS algorithm module 505. The LMS algorithm module calculates new coefficients of the adaptive controller 502 and inputs these new values to the controller via signal path 507. The internal noise disturbance signal dᵢ(k) and the external noise disturbance signal de(k) are related by the transfer function H(z).

The transfer function H(z) can be used to determine the desired characteristics of the controller 502 as follows:

We have the equality H(z)dₑ(z)=H(z)X(z) and also that \tilde{P}(z)U(z)=\tilde{P}(z)\tilde{C}(z)X(z), where \tilde{C}(z) is the transfer function of the controller 502. The error equation is:

E(z)=H(z)X(z)−\tilde{P}(z)C(z)X(z) (18)

For the error to equal zero we must have:

\tilde{C}(z)=H(z)*\tilde{P}(z)⁻¹ (19)

In most ANC systems it is unusual to have a sufficiently detailed knowledge of the system such that the plant coefficients p_{M}(k) can be predicted without any measurements of the input or output signals of the plant and so in most cases the plant model is obtained experimentally from measurements of the real system. In the case of a digital controller the plant is taken to include all further components that are necessary to enable digital control of an analogue plant and disturbance signal. These components include the digital to analogue converters (DAC), analogue to digital converters (ADC), the DAC reconstruction low pass filter and the ADC anti-aliasing low-pass filter, the loudspeaker and microphone amplifiers, the acoustic path between loudspeaker and microphone and the microphone and loudspeaker impulse responses.

Feedforward controllers have the advantage over feedback controllers that corrective action is taken for a change in the disturbance signal before it affects the control parameter. In the case of ANC, undesired acoustic feedback from the cancelling loudspeaker back to the reference microphone is also avoided. However feedforward control requires detailed knowledge of the plant response to a given input signal u(k). Because there is no error signal feedback, if the plant model is poor the output signal u(k) of the controller is unlikely to lead to good noise cancellation. Furthermore in typical feedforward control systems a disturbance signal measured externally to the system is used to produce a signal that at least partially cancels out a disturbance signal measured internally to the system. This requires knowledge of how the noise will vary across the system, which in turn requires knowledge of the transfer function H(z).

In contrast to feedforward systems, typical circuits utilising feedback ANC contain only one microphone. This microphone is used to measure the residual noise obtained from the superposition of the ambient noise Nᵢ(t) and the generated anti-noise. The measured residual noise is then converted by the microphone into an error signal, the error signal then being fed back into the controller. Because of this adaptive feedback controllers can only cancel out predictable noise components of the primary noise. A combination of a feedforward and feedback adaptive controller is called a hybrid system and overcomes many of the disadvantages of the individual feedforward and feedback systems.

A hybrid ANC system is shown in FIG. 6. Section 601 is the feedforward portion of the hybrid system and section 602 is the feedback portion section of the hybrid system. A microphone 603 external to the ANC system records external noise Ne(k). This noise is converted by the microphone 603 into a disturbance signal dₑ(k). The disturbance signal dₑ(k) is the feedforward reference signal x_{ff}(k). The feedforward reference signal x_{ff}(k) is input into a feedforward adaptive controller 604. The output of the adaptive controller 604 is a signal u_{ff}(k), which is input into a first summing junction 605. The output signal of the first summing junction 605 is input into a plant 606 with corresponding transfer function \tilde{P}(z). The output signal of the plant 606 is input to a second summing junction 607. At the second summing junction 607 the output signal of the plant 606 and a disturbance signal dᵢ(k) are summed to produce an error signal e(k). The disturbance signal dᵢ(k) is equal to the output of a microphone that recorded only the disturbance noise internal to the ANC system. The error signal e(k) is input into a first LMS algorithm module 608, a second LMS algorithm module 609 and a third summing junction 610. A feedforward reference signal x_{ff}(k) is input into a first plant estimate 611 and the output signal is a filtered feedforward reference signal \hat{x}_{ff}(k), which is input into the LMS algorithm module 608. The LMS algorithm module calculates new coefficients for the feedforward adaptive controller 604. The updated values of the coefficients are input to the controller 604 via the signal path 616.

A feedback reference signal x_{fb}(k) is input into a feedback adaptive controller 612. The output signal from the controller 612 is a signal u_{fb}(k). The output signal u_{fb}(k) is input into a second plant estimate 613 and the first summing junction 605. At the first summing junction 605 the output signals u_{ff}(k) and u_{fb}(k) of the feedforward adaptive controller 604 and feedback adaptive controller 612 are summed. At the third summing junction 610 the output from the second plant estimate 613 and the error signal e(k) are summed to produce a feedback reference signal x_{fb}(k). The signal x_{fb}(k) is input into a third plant estimate 614. The output of the third plant estimate 614 is the filtered feedback reference signal \hat{x}_{fb}(k). This filtered reference signal is input into the LMS algorithm module 609. The LMS algorithm module calculates new coefficients for the feedback adaptive controller 612. The updated values of the coefficients are input to the controller 612 via the signal path 615.

In a typical circuit implementing a hybrid ANC system the external microphone is kept close to the primary noise source and provides a reference signal for the feedforward system. The internal microphone is placed near where noise cancellation is desired and measures the residual noise and generates a signal for the adaptive feedback ANC controller. This system thus allows both the primary noise and the predictable components of the primary noise that are not measured by the external microphone to be attenuated.

It is highly desirable for an ANC system to operate over a broad frequency range of noise. However broadband ANC can lead to adaptive controllers with hundreds of coefficients. This leads to a large computational burden and subsequently slow convergence of the adaptive algorithm used to obtain the coefficients. A technique for circumventing these problems is to process the signals in sub-bands. This reduces the computational burden and also leads to a faster convergence of the adaptive algorithm because the spectral range of each sub-band is significantly reduced compared to the spectral range of the broad band. A problem with this approach is that the bandpass filters used to process each sub-band introduce a substantial delay into the signal path, which limits the bandwidth over which good noise cancellation can be achieved. A modification to the sub-band technique has been developed that eliminates this delay.

An example of a delay-less sub-band system is shown in FIG. 7. In the delay-less sub-band system of FIG. 7 a feedforward ANC system is employed. A reference signal x(k) is input into an adaptive controller 701. The output of the adaptive controller 701 is a signal u(k), which is input into a plant 702 with corresponding transfer function \tilde{P}(z). The output signal of the plant 702 is input into a summing junction 703. At the summing junction 703 the output signal of the plant 702 and a disturbance signal dᵢ(k) are summed, producing an error signal e(k). The reference signal x(k) is input into a plant estimate 704 with corresponding transfer function P̅(z), and the output signal of the plant estimate 704 is a filtered reference signal \hat{x}(k). The filtered reference signal \hat{x}(k) and the error signal e(k) are input into a filter bank 705. The filter bank 705 consists of sub-band filters that decompose x(k) and e(k) into M sub-band signals e₀(k), e₁(k), . . . e_{M-1}(k) and \hat{x}₀(k), \hat{x}₁(k), . . . \hat{x}_{M-1}(k). Each corresponding pair of filtered reference signals and error signals (i.e. e₀(k) and \hat{x}₀(k), e_{M-1}(k) and \hat{x}_{M-1}(k)) is then input into an LMS algorithm module 706. Each LMS algorithm module 706 then calculates the adaptive controller coefficients for each of the sets of sub-band signals and outputs these coefficients into a Fast Fourier Transform (FFT) module 707 which transforms the coefficients into the frequency domain. The transformed coefficients are then output from the FFT modules 707 to a frequency stacking module 708. The frequency stacking module 708 appropriately stacks the coefficients and then outputs the stacked coefficients into an inverse FFT module 709. The inverse FFT module transforms the coefficients back into the time domain. The output of the inverse FFT module 709 is the wideband controller coefficients. The values of the coefficients are input into the controller by signal path 710. The delay-less sub-band LMS algorithm module is denoted by 711.

Despite the inherent advantages of using an adaptive controller, fixed controllers are still used for many commercial applications. Adaptive controllers require an additional piece of circuitry compared to fixed controllers which increases the power consumption of the circuit. This can have particular implications for ANC systems that utilise Bluetooth such as in Bluetooth headphones, because Bluetooth is a low power means of communication. Adaptive controllers are also more computationally complex compared to fixed controllers, particularly if the delay-less sub-band adaptive controller is adopted. This increases the difficulty of manufacture of the controller and hence the cost of the ANC system as a whole. Perhaps most importantly, for many applications the response of the plant does not change significantly over the timescales of operation of the system. In this case if the behaviour of the plant is approximately constant (i.e. its impulse response remains approximately constant) then the coefficients of the controller are still “correlated” to its response, and there is no need for an adaptive controller. Other situations where an adaptive controller may not be necessary arise when the ANC system is used in environments in which the ambient noise is largely constant and operates over a small spectral range. In situations where the background noise varies and can operate over a large spectral range, the controller may not contain a sufficient number of coefficients in order to generate an adequate anti-noise signal across the whole frequency range. In these circumstances being able to alter the coefficients of the controller would be beneficial, but many situations exist where this is not the case. Fixed controllers are thus still important for many commercial applications.

Difficulties with fixed controllers arise during their design phase; without an adaptive algorithm to determine the optimum coefficients for the controller they must be engineered manually. Depending on the complexity of the ANC system and the number of coefficients this can be a significant undertaking. In the past controllers were designed using classical control theory in which the frequency response of the controller was engineered for a specific application. Engineering the coefficients requires an accurate plant model and a reasonable characterisation of the uncertainties. The difficulty in selecting the coefficients has led to the development of computer aided controller design, but these methods still require significant computational effort and skill.

There is thus a need for an improved method of obtaining the coefficients for a fixed controller that reduces the computational complexity and that can be applied to ANC systems manufactured on a mass scale with reduced cost compared to current methods.

According to the present invention there is provided a method for obtaining coefficients for a non-adaptive controller for use in an active noise control system, the method comprising: capturing experimental data from a target system to characterise the plant of the target system; and implementing an adaptive algorithm to compute the coefficients in dependence on the experimental data.

Suitably the operation of the controller comprises running a non-adaptive algorithm.

Preferably the non-adaptive algorithm is pre-programmed.

Preferably the value(s) of the coefficient(s) are programmable in the non-adaptive controller.

Preferably the adaptive algorithm adjusts the value(s) of the coefficient(s) in order to minimise an error signal.

Preferably the adaptive algorithm is implemented in sub-bands.

Suitably the method comprises obtaining coefficients for the controller for use in an active noise control system that is a feedforward, feedback or hybrid feedforward/feedback system.

Preferably the adaptive algorithm obtains the coefficients automatically and independently of the system to be controlled.

Preferably the adaptive algorithm is implemented prior to the operation of the non-adaptive controller.

Preferably the method comprises the steps of configuring the target system to simulate a production system and implementing in the production system an active noise control system having a non-adaptive controller using the computed coefficients.

According to a second aspect of the present invention there is provided an integrated circuit configured to implement a non-adaptive active noise control algorithm, the integrated circuit being configured to be externally programmable with one or more coefficients and to implement the active noise control algorithm in accordance with the coefficients.

According to a third aspect of the present invention there is provided a method of configuring an audio device, the audio device being integrated with a noise source and having a microphone and a loudspeaker and an integrated circuit that is capable of implementing a non-adaptive noise control algorithm to at least partially remove from an output signal of the microphone noise derived from the noise source, the method comprising: testing a sample device having analogous audio properties to the said audio device to estimate the properties of the sample device; determining in dependence on the estimated properties one or more coefficients for use in the non-adaptive noise control algorithm; and storing those coefficients in the said audio device for use by it in implementing the non-adaptive noise control algorithm.

Suitably the said determining step comprises implementing an adaptive noise control algorithm.

Suitably the said determining step is performed using processing means other than the integrated circuit.

### BRIEF DESCRIPTION OF THE DRAWINGS

The present invention will now be described by way of example with reference to the following drawings. In the drawings:

FIG. 1 is an example of a feedback ANC system.

FIG. 2 is a block diagram representation of FIG. 1.

FIG. 3 is an example of a block diagram of an unstable adaptive feedback controller.

FIG. 4 is an example of a block diagram of an adaptive feedback controller implementing the FXLMS algorithm.

FIG. 5 is an example of a block diagram of an adaptive feedforward controller implementing the FXLMS algorithm.

FIG. 6 is an example of a block diagram of an adaptive hybrid feedforward-feedback controller implementing the FXLMS algorithm.

FIG. 7 is a block diagram of a delay-less sub-band adaptive filter implementing the FXLMS algorithm.

FIG. 8a is a diagram of the set-up used to determine the plant impulse response experimentally, and FIG. 8b is a block diagram of the apparatus used to determine the plant model by means of an adaptive algorithm.

FIG. 9 is a block diagram of an adaptive feedforward controller implementing a delay-less sub-band FXLMS algorithm to compute the controller coefficients c_{ff}(k) for given primary noise Nₑ(k) and internal noise Nᵢ(k).

FIG. 10 is a block diagram of an adaptive feedback controller implementing a delay-less sub-band FXLMS algorithm to compute the controller coefficients c_{fb}(k) for internal noise Nᵢ(k).

FIG. 11 is a block diagram of an adaptive hybrid feedforward-feedback controller implementing a delay-less sub-band FXLMS algorithm to compute the feedback controller coefficients c_{fb}(k) and a delay-less sub-band FXLMS algorithm to compute the feedforward controller coefficients c_{ff}(k).

FIG. 12 is the main screen of the GUI program used to obtain the plant response and controller coefficients within one application.

FIG. 13 is the recording panel of the GUI. It is used to record wave files that are used to compute both the plant and the controller. The wave files can be chosen by the user depending on the type of ANC system and the intended environment of use of the ANC system.

FIG. 14 is the plant design panel of the GUI. Source files can be chosen by the user to calculate the plant impulse response.

FIG. 15 is the controller design panel of the GUI. An adaptive algorithm is run to compute the controller coefficients for use in an ANC system, utilising experimental data files that can be chosen by the user.

FIG. 16 is the DSP download panel of the GUI. This panel allows the calibration values and calculated controller coefficients from the controller design panel to be downloaded onto a DSP chip, the chip then being configured to operate using those values.

FIG. 17 is a block diagram of an example application of a DSP in an ANC system.

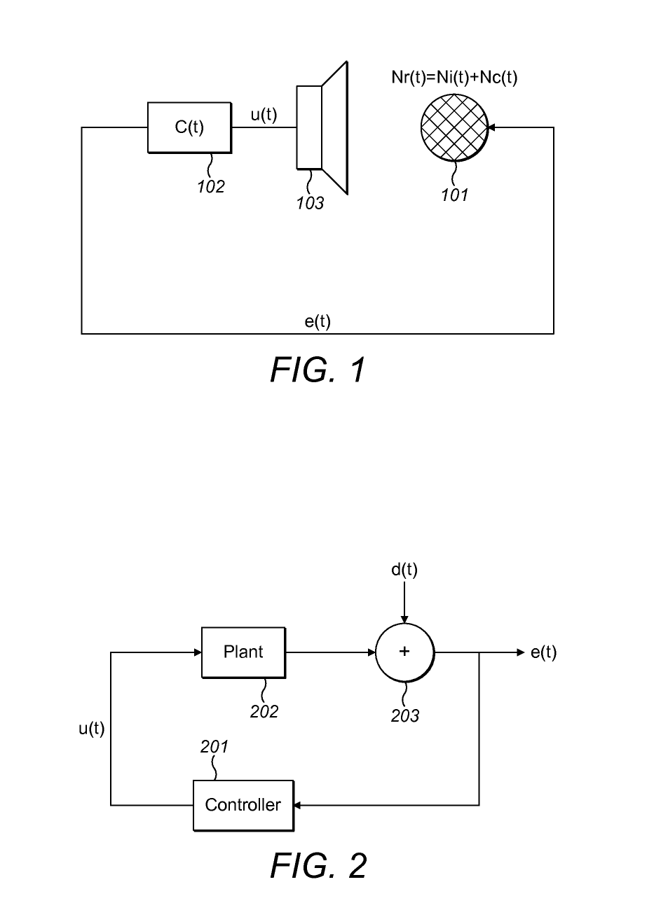

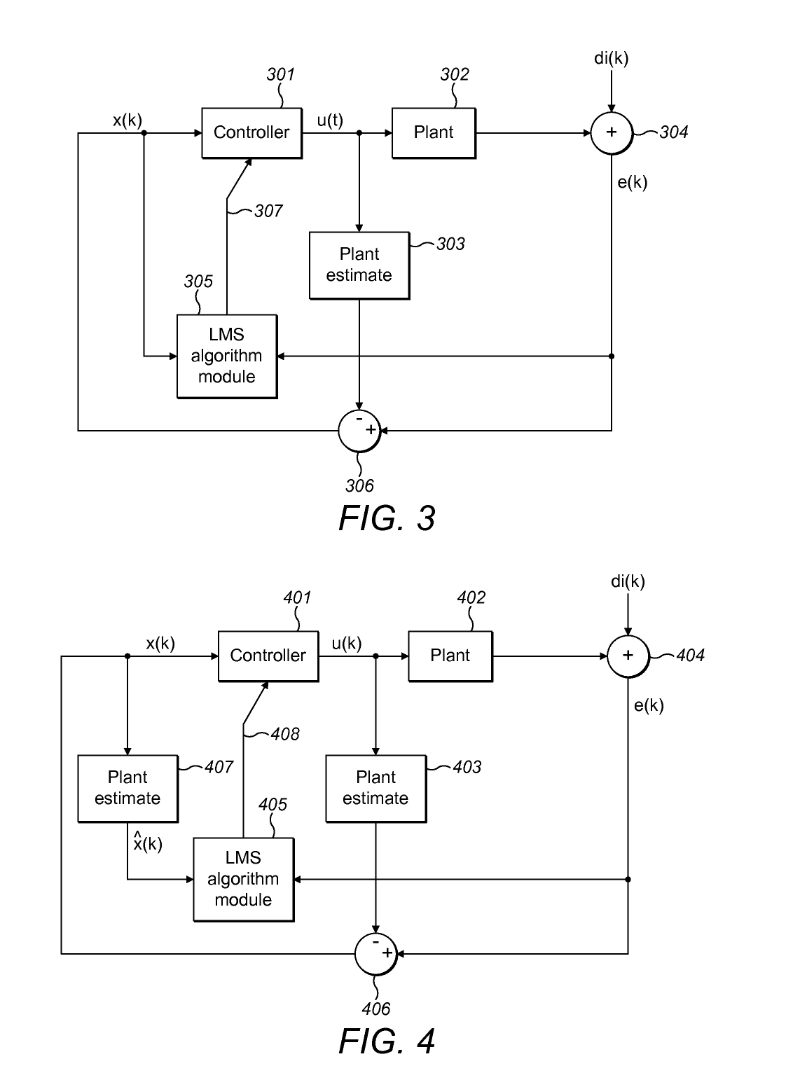

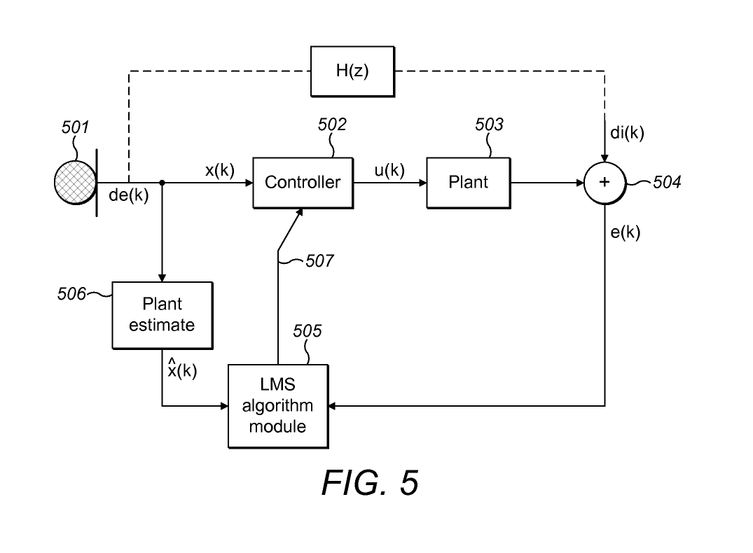

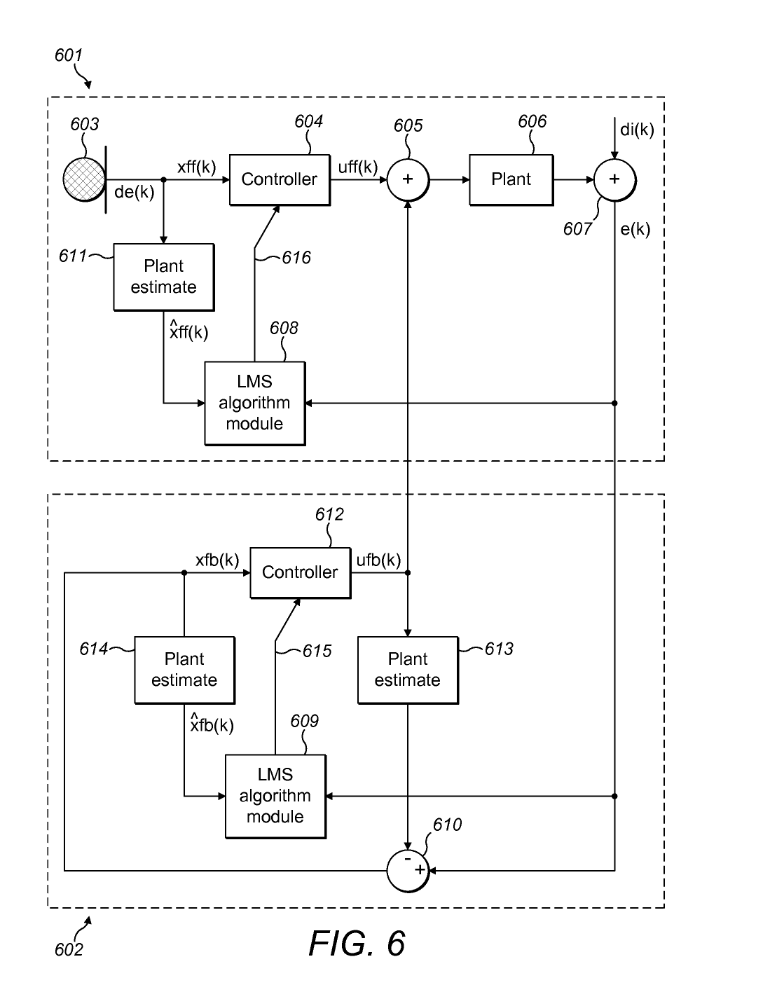

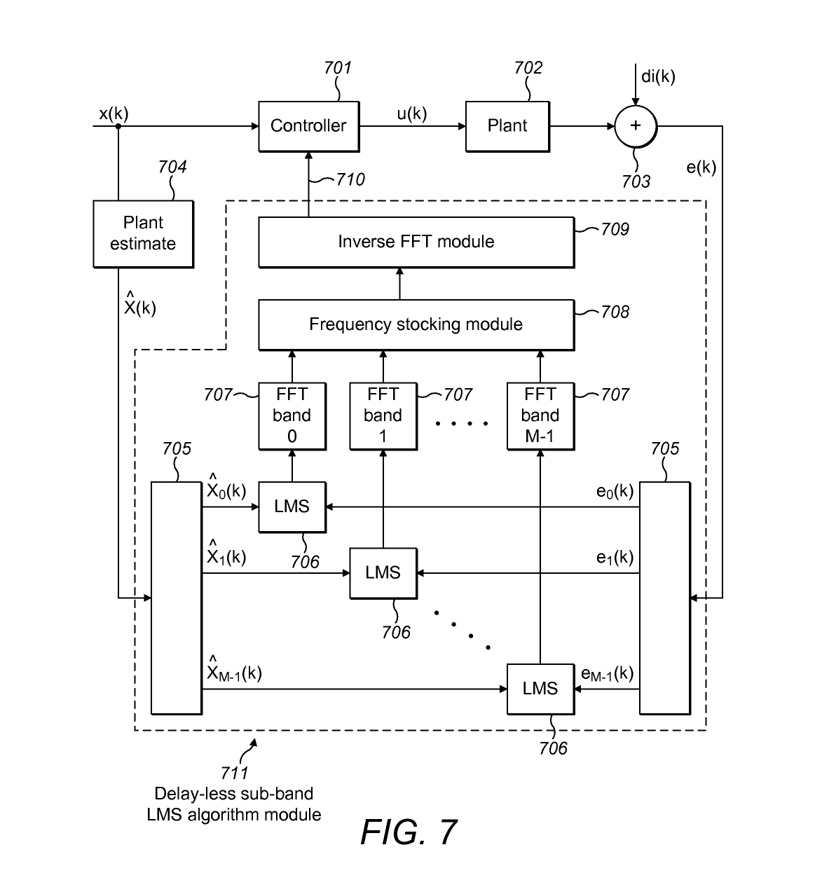

### DETAILED DESCRIPTION

The method described below provides a means of obtaining fixed coefficients for a controller that is to be used in an ANC system. The method described is an offline method in that for a given ANC system the fixed coefficients of the controllers can be pre-calculated using experimental data. This experimental data may be noise characteristic of the intended environment of use of the ANC system. The calculated coefficients of the controller can then be stored and subsequently programmed into any number of devices (e.g. integrated devices/chips) for use in actual ANC systems.

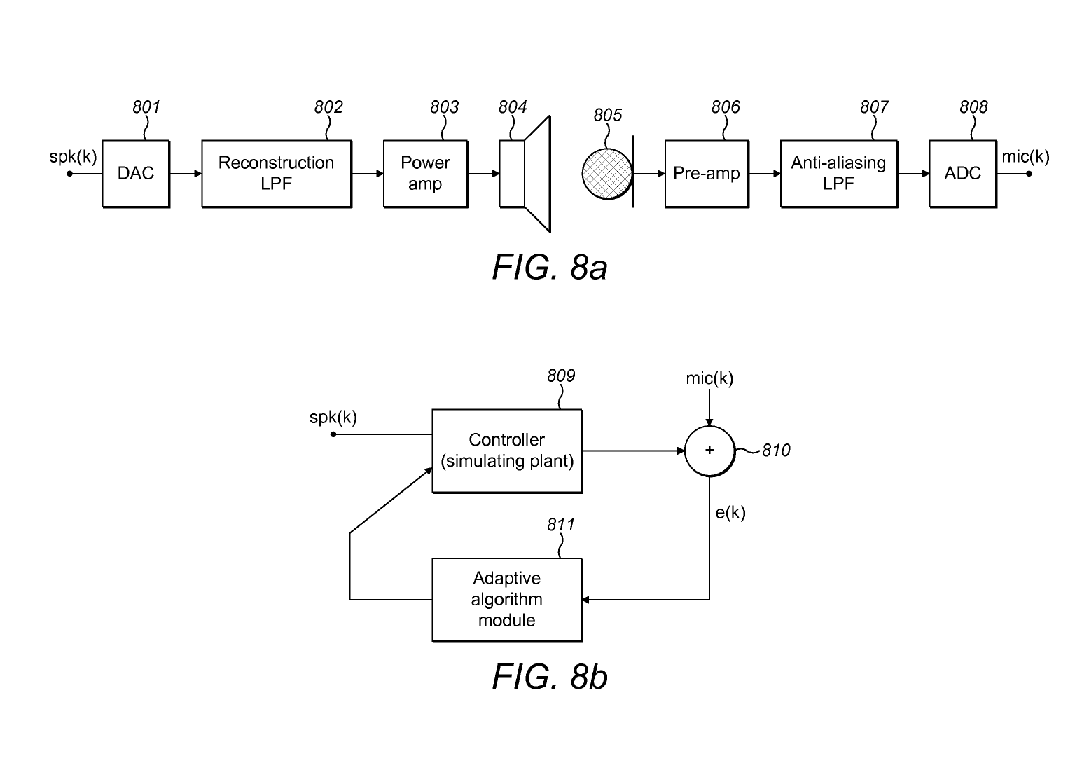

In order to obtain the fixed coefficients of a controller, it is desirable to obtain the coefficients of the plant of the system. This may be done by use of experimental sound recordings. An example of obtaining the coefficients of a plant by use of sound recordings is shown in FIG. 8.

An input signal spk(k) is input into a digital-to-analogue converter (DAC) 801. The output signal from the DAC is input into a reconstruction low-pass filter (LPF) 802, the output of which is fed into a power amp 803. The output signal from the power amp is input into a loudspeaker 804. A microphone 805 records the ambient noise and the noise generated by the loudspeaker 804. The output signal of the microphone 805 is fed into a pre-amp 806. The output from the pre-amp 806 is input into an anti-aliasing LPF 807. The output signal from the anti-aliasing LPF is input into an analogue to digital converter (ADC) 808. The output signal of the ADC 808 is a signal mic(k).

In a practical application of an adaptive controller, the use of a digital controller requires additional components including a DAC, ADC, reconstruction low-pass filter (LPF), an amp and an anti-aliasing LPF. This is because whilst the controller may be digital, i.e. it operates on discrete time signals, the signal under control is an analogue signal.

The output of an ADC converter is typically a sequence of piecewise constant values. This means that it will typically contain multiple harmonics above the Nyquist frequency, and so to properly reconstruct a smooth analogue signal these higher harmonics must be removed. Failure to remove these harmonics could result in aliasing. This is the role of the reconstruction low pass filter.

Aliasing is also a problem when converting the signal from analogue back to digital. If the analogue signal contains frequencies much higher than the sampling rate then the digitised sample will be unable to be reconstructed to the correct analogue signal. To avoid aliasing, the input to an ADC can be low-pass filtered to remove frequencies above half the sampling rate. This is the role of the anti-aliasing filter.

In a practical implementation of the circuit depicted by FIG. 8a, for example in an ANC system, the signal spk(k) could be the output of a digital controller. The z-domain transfer function from the sampled input signal spk(k) to the sampled output signal mic(k) is the effective plant response seen by the digital controller. This transfer function, \tilde{P}(z), corresponds to the plant response effectively seen by the digital controller. It is the transfer function of the system under control and for digital controllers includes the impulse responses of the ADC, Reconstruction LPF, Power Amp, loudspeaker, microphone, pre-amp, anti-aliasing LPF and ADC.

A digital output signal of the plant mic(k) in response to an input signal spk(k) is recorded. The digital input signal spk(k) may be raw experimental data. The coefficients of the plant may now be calculated using an adaptive algorithm as shown in FIG. 8b.

The signal spk(k) is input into an adaptive controller 809. The output of the adaptive controller is input into a summing junction 810. At the summing junction the output of the adaptive controller 809 is subtracted from the recorded signal mic(k) to produce an error signal e(k). An adaptive algorithm is used to update the coefficients of the adaptive controller in order to minimise this error signal. The adaptive algorithm is carried out in an adaptive algorithm module 811. The adaptive algorithm module 811 outputs the values of the coefficients to the adaptive controller 809. If coefficients are found such that the error signal is zero, then the output of the adaptive controller will be equal to the signal mic(k), and hence the coefficients of the adaptive controller are such that the adaptive controller exactly models the plant. In practice the adaptive algorithm will run until the error signal has converged. The coefficients of the plant are found when the error signal has converged. Once the coefficients of the plant are found the corresponding transfer function of the plant can be calculated, by, for example, equation 5.

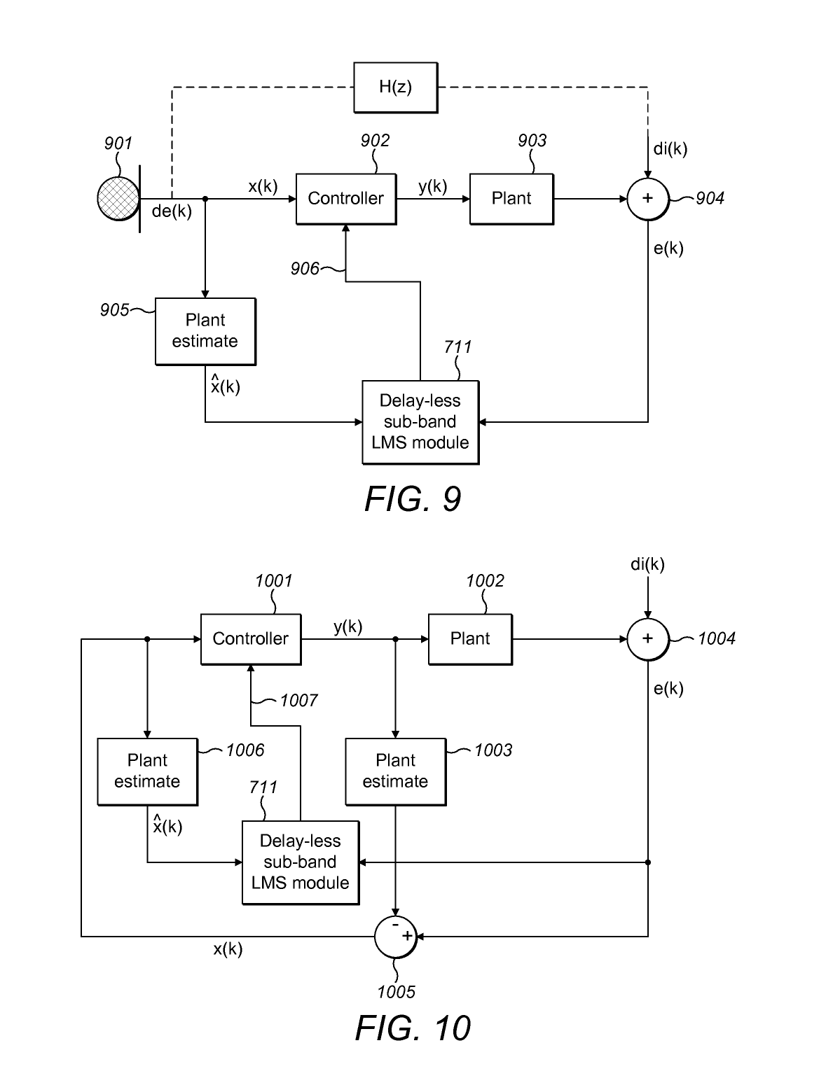

This method is applicable to any ANC system. All that is required is that the plant and recording microphone is set-up as required for a particular ANC system. After obtaining the plant coefficients pₘ, fixed coefficients of a controller for use in a feedforward ANC system may be estimated using the delay-less FXLMS adaptive algorithm in sub-bands as shown in FIG. 9.

A microphone 901 records an external noise Nₑ(k). This noise is converted by the microphone into a disturbance signal dₑ(k). In this situation the disturbance signal dₑ(k) is the reference signal x(k). The reference signal is input into a controller 902. The output of the controller 902 is a signal y(k), which is the input signal to a plant 903. The output of the plant 903 is input into a summing junction 904. At the summing junction the output signal of the plant 903 and a second disturbance signal dᵢ(k) are summed together to produce an error signal e(k). The disturbance signal dᵢ(k) is the signal that would be output from a microphone that recorded only the internal disturbance noise. The reference signal x(k) is input into a plant estimate 905. The output of the plant estimate 905 is a filtered reference signal \hat{x}(k). The filtered reference signal and the error signal are input into a delay-less sub-band LMS module 711. The delay-less sub-band LMS module computes the controller coefficients and inputs the values of the calculated coefficients to the controller 902 via signal path 906. This process may run until the error signal e(k) has converged.

Note that in a typical circuit implementing feedforward ANC, the internal microphone is only required during the design process and that once the controller coefficients have been calculated the system will typically only consist of the external microphone. The noise Ne(k) may represent the noise environment in which the ANC system will be used. The controller could be a finite impulse response controller. The plant coefficients pₘ of the plant 903 may be those obtained from the process depicted in FIG. 8. This conveniently means the same method of obtaining controller coefficients can be used for a multitude of ANC systems, all that is required is that the noise signal be representative of the noise in the target application environment. Note however that the system will also attenuate noise if the power density distribution of the input noise is different from that used to obtain the controller coefficients.

An advantage of implementing the FXLMS algorithm in sub-bands is that it allows the error signal to be minimised within each sub-band, allowing the noise to be attenuated across a broad band of frequency without substantially increasing the number of coefficients used in the controller. Having a large number of coefficients in the controller requires substantial computational effort and utilising a sub-band structure is a more efficient way of attenuating the noise across a broad frequency band. The number of sub-bands required depends on the sampling frequency of the system, and increases as the sampling frequency increases.

The adaptive algorithm may be run until the error signal has converged. If the error signal is zero then the output of the plant is a signal that perfectly cancels out the disturbance signal dᵢ(k).

A block diagram of the apparatus used to determine the coefficients of a controller for use in a feedback ANC system is shown in FIG. 10. The output of a controller 1001 is a signal y(k). The output signal y(k) is input into a plant 1002 and a plant estimate 1003. At a summing junction 1004 the output of the plant 1002 and a disturbance signal dᵢ(k) are summed together to produce an error signal e(k). The disturbance signal dᵢ(k) is the signal that would be output from a microphone that recorded only the internal disturbance noise. The output signal of the plant estimate 1003 and the error signal are summed together at a second summing junction 1005 to produce a reference signal x(k), which is an estimate of the disturbance signal dᵢ(k). The reference signal x(k) is input into the controller 1001 and a second plant estimate 1006. The output of the second plant estimate 1006 is a filtered reference signal \hat{x}(k). The filtered reference signal \hat{x}(k) and the error signal e(k) are input into a delay-less sub-band LMS algorithm module 711. The delay-less sub-band LMS algorithm module calculates new coefficients of the controller 1001 and inputs these new values via the signal path 1007.

The plant coefficients used in the plant models 1006 and 1003 used in this circuit may be obtained using the same method as depicted in FIG. 8. Once the plant estimate is obtained, the delay-less FXLMS algorithm in sub-bands is used to obtain the controller coefficients cₙ(k). The controller 1001 is pre-programmed to output a signal y(k) in dependence on an input signal x(k−n) and the coefficients cₙ(k). The controller could be a finite impulse response controller. The adaptive algorithm is run until the error signal has converged. The values of the coefficients are those for which the error signal has converged. Note that in a typical circuit implementing feedback ANC there is only one microphone; the internal microphone used to record the residual noise. The residual noise is formed from the superposition of disturbance noise internal to the ANC system and the noise output from the loudspeaker. The disturbance signal dᵢ(k) could be the output of a microphone that records noise representative of the noise from the intended environment of use of the ANC system.

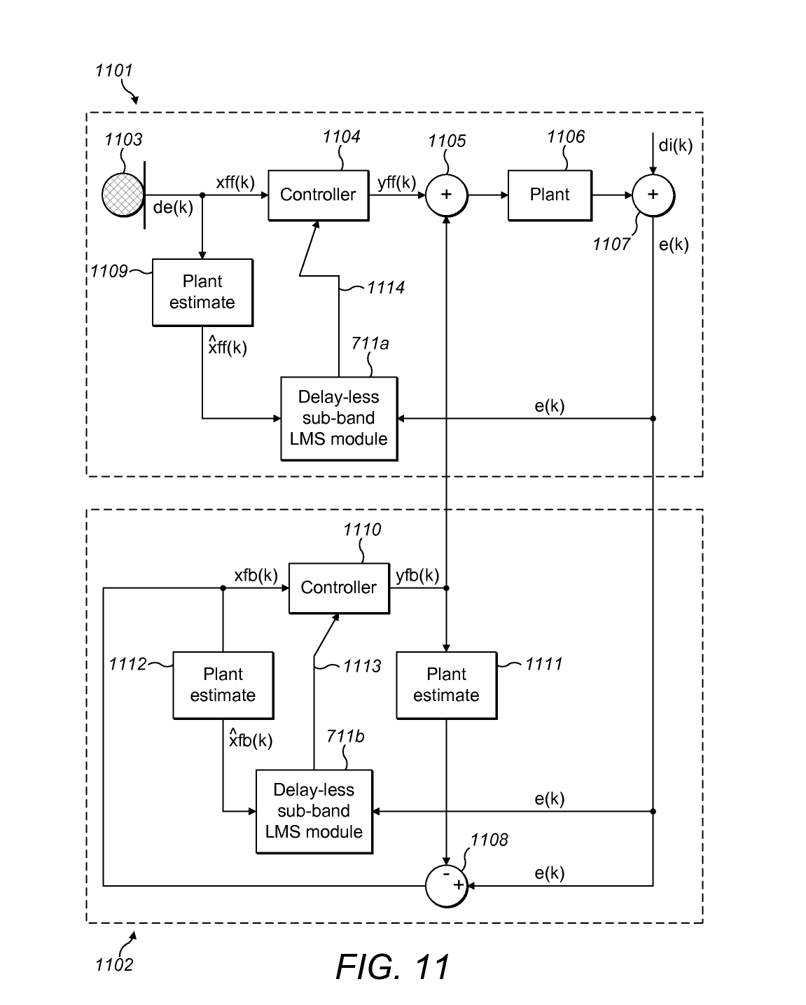

A method to adaptively obtain a first and second controller for use in a hybrid ANC system is shown in FIG. 11.

The section 1101 is the feedforward portion of the hybrid system and section 1102 is the feedback portion section of the hybrid system. A microphone 1103 external to the ANC system records noise Ne(k). This recorded noise is used as a reference signal x_{ff}(k) and is input into a controller 1104. The output of the controller 1104 is a signal y_{ff}(k), which is input into a first summing junction 1105. The output signal of the summing junction 1105 is input into a plant 1106. The output signal of the plant 1106 is input to a second summing junction 1107. At summing junction 1107 the output signal of the plant 1106 and a disturbance signal dᵢ(k) are summed to produce an error signal e(k). The disturbance signal is the signal that would be output by a microphone that recorded only the internal disturbance noise. The error signal e(k) is input into a first delay-less sub-band LMS algorithm module 711a, a second delay-less sub-band LMS algorithm module 711b and a third summing junction 1108. The feedforward reference signal x_{ff}(k) is input into a first plant estimate 1109 and the output signal is a filtered feedforward reference signal \hat{x}_{ff}(k), which is input into the delay-less sub-band LMS algorithm module 711a. The delay-less sub-band LMS algorithm module 711a calculates new values for the coefficients of the controller 1104. The updated values of the coefficients are input to the controller 1104 via the signal path 1114.

A feedback reference signal x_{fb}(k) is input into a second controller 1110. The output signal from controller 1110 is a signal y_{fb}(k). The output signal y_{fb}(k) is input into a second plant estimate 1111 and the first summing junction 1105. At the summing junction 1105 the first controller output signal y_{ff}(k) is summed with the second controller output signal y_{fb}(k). At the summing junction 1108 the output from the plant estimate 1111 and the error signal e(k) are summed to produce the feedback reference signal x_{fb}(k). The signal x_{fb}(k) is input into a third plant estimate 1112. The output of the plant estimate 1112 is a filtered feedback reference signal \hat{x}_{fb}(k). This filtered reference signal is input into the delay-less sub-band LMS algorithm module 711b. The delay-less sub-band LMS algorithm module 711b calculates new values for the coefficients of the controller 1110. The updated values of the coefficients are input to the controller 1110 via the signal path 1113.

The plant coefficients used in the plant estimates 1109, 1111 and 1112 in this circuit may be obtained using the method depicted in FIGS. 8a and 8b. The coefficients of the controllers used in the feedforward and feedback portions of a circuit implementing ANC are obtained using the delay-less FXLMS adaptive algorithm in sub-bands. The fixed coefficients of the controllers 1104 and 1110 are obtained after the convergence of the error signal. The first controller could be a finite impulse response controller. The second controller could be a finite impulse response controller. Each controller is pre-programmed to output a signal in dependence on its input signal and its coefficients as shown by, for example, equation 16.

Once the coefficients of the fixed controllers have been computed, the values can be programmed onto a multitude of DSPs. The DSPs can then be implemented into a chosen target ANC system, having now been programmed for use.

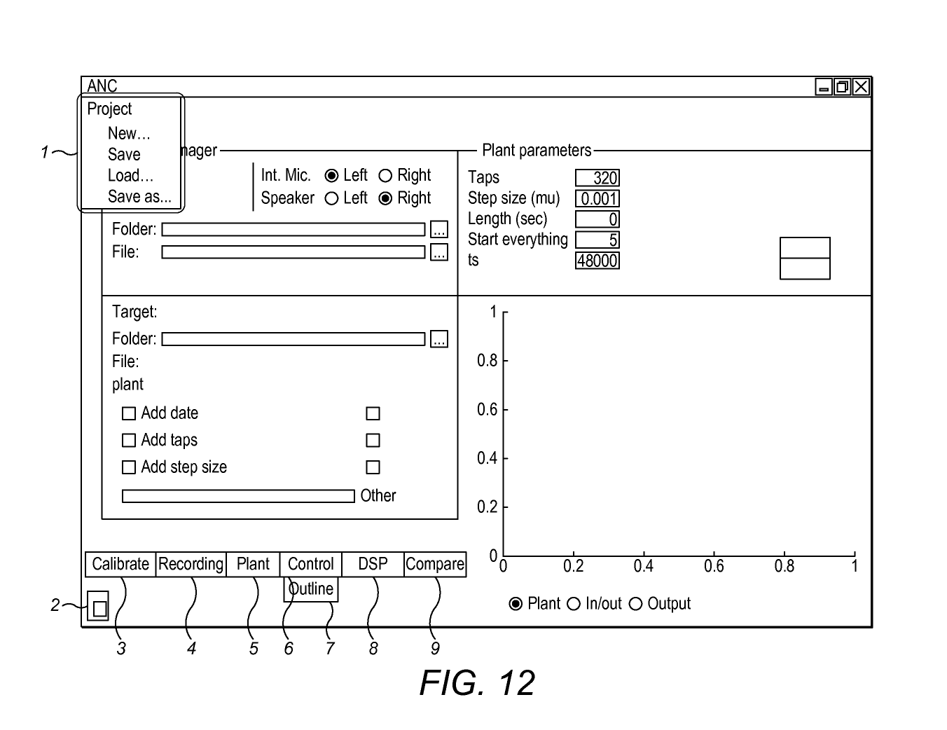

The graphical user interface (GUI) shown in FIG. 12 provides a complete environment in which the user can execute all the design requirements of the ANC system described above within one application. This includes the calculation of both the plant and controller coefficients. The “project” tab allows the user to manage and design a project, allowing him to save and load different configurations. “Administrator mode” allows a third party to access information required for debugging purposes. The calibration panel allows the user to configure the different gains found in the DSP. The gains can be tuned to obtain the best performance from the system and saved to a file for later use within the DSP. The recording panel permits the recording of wave files needed to calculate both the plant and the controller coefficients. These recordings will be used in the plant design and controller design panels. The “DSP download” tab allows the DSP to be configured with the calibration file and the ANC controller file, the ANC controller file being obtained from the controller design panel.

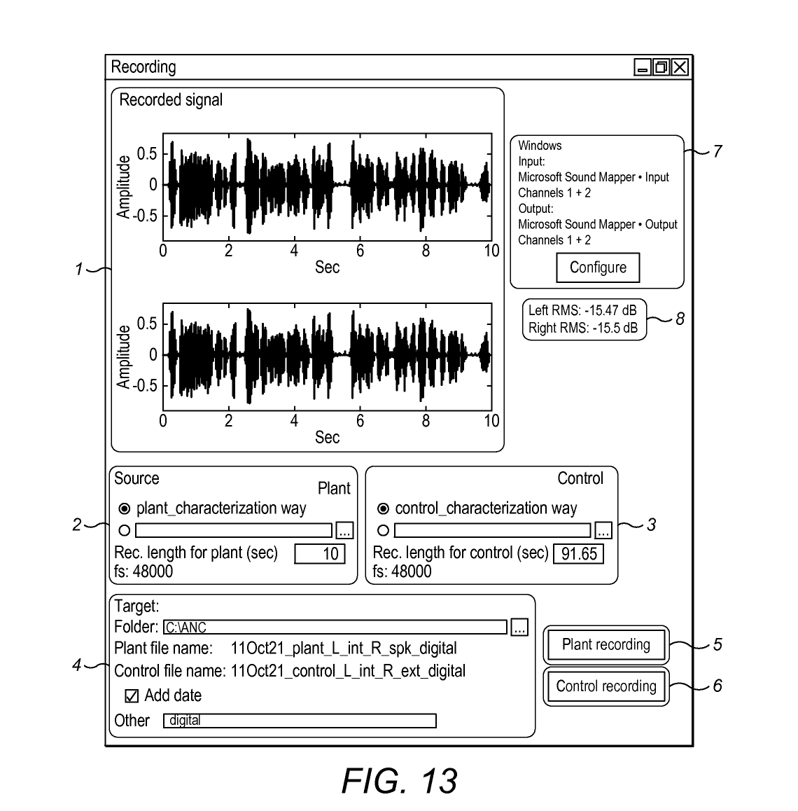

The recording panel is shown in FIG. 13. The “source” tab is used to select the file to be played to characterise either the plant or the controller. The selected wave file will be recorded to produce a recorded signal. The recorded signals could be used as the input signal spk(k) used to determine the plant impulse response and plant coefficients as depicted in FIG. 8. The recorded signals could be used as the disturbance signals dₑ(k) and dᵢ(k) used to determine the controller coefficients as depicted in FIGS. 9-11. The selected wave files can be wave files recorded from a noise environment similar to the intended environment of use of the ANC headphones. The recording tabs record these files so that they can be utilised by the user in the plant and controller design panels.

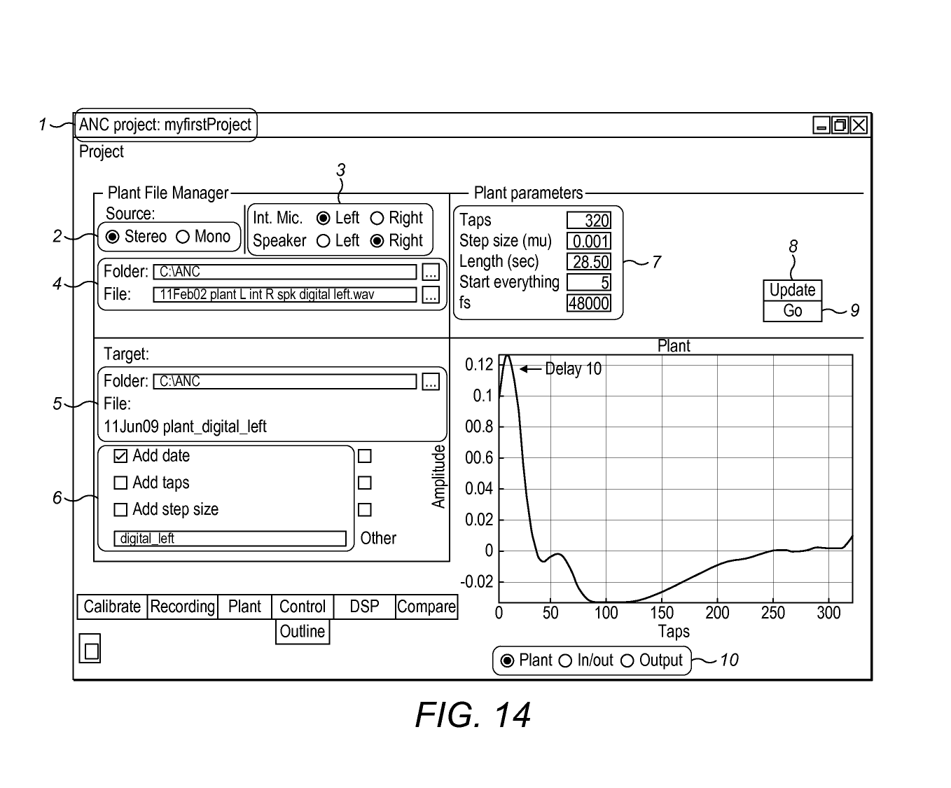

The plant design panel is shown in FIG. 14. Parameters including the step size of the LMS algorithm and the number of coefficients of the plant can be adjusted using this panel. The algorithm that determines the plant coefficients p_{M}(k) is run from this panel and the values of the coefficients obtained after convergence of the algorithm are displayed. It is also possible to display the error signal or the impulse response of the plant. The recorded signals used to determine the plant coefficients can also be chosen in this panel.

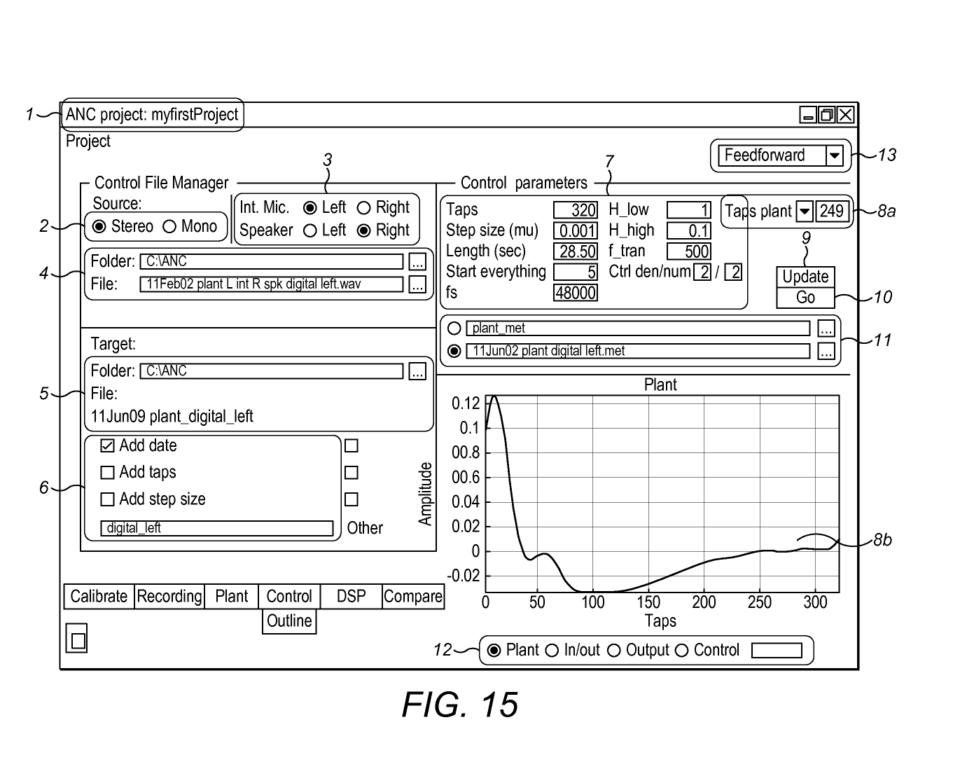

The online controller design panel is similar to the plant design panel and is shown in FIG. 15. The number of coefficients of the controller and the step size of the delayless FXLMS algorithm in subbands can again be adjusted. The recorded signals used to determine the controller coefficients can be selected in this panel. The coefficients of a controller for use in differing background noises can be calculated by choosing the relevant source files from the “Source files” tab in this panel. The source files will be chosen from a list of recorded signals. The recorded signals are used as the disturbance signals dᵢ(k) and dₑ(k) as described above with reference to FIGS. 9-11. The coefficients of a controller for use in differing ANC systems can be calculated by selecting, using the “Plant source” tab, the relevant plant source to be used. Once the correct plant model and noise have been selected by the user the adaptive algorithm can then be used to calculate the controller coefficients.

The offline design panel allows the user to design infinite impulse response filters (IIR) of the controllers from the finite impulse response (FIR) that was calculated in the online controller design panel. This speeds up the design of the IIR response controller because parameters can be changed without having to go through the FIR calculation in the online controller design panel. This advantageously allows the user to calculate both a FIR filter of a controller and an IIR response filter of a controller, depending on the application. IIR filters have the advantage that they require fewer coefficients than FIR filters, although they can be unstable.

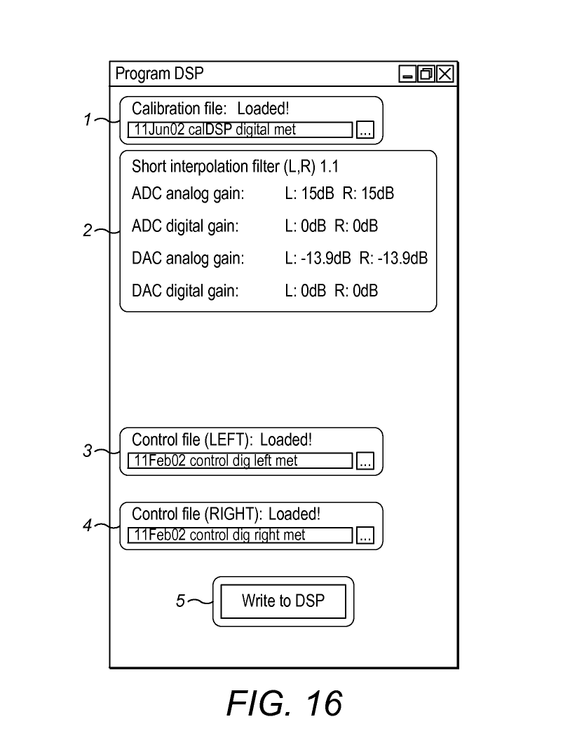

The DSP download panel is shown in FIG. 16. This allows the calibration values and controller coefficients to be downloaded to a DSP. The DSP is now configured to use these gains and coefficients. Thus once the coefficients of the controller have been calculated the values can be downloaded to any number of DSP chips.

The fixed coefficients could be calculated according to other mechanisms. Other ANC algorithms could be used.

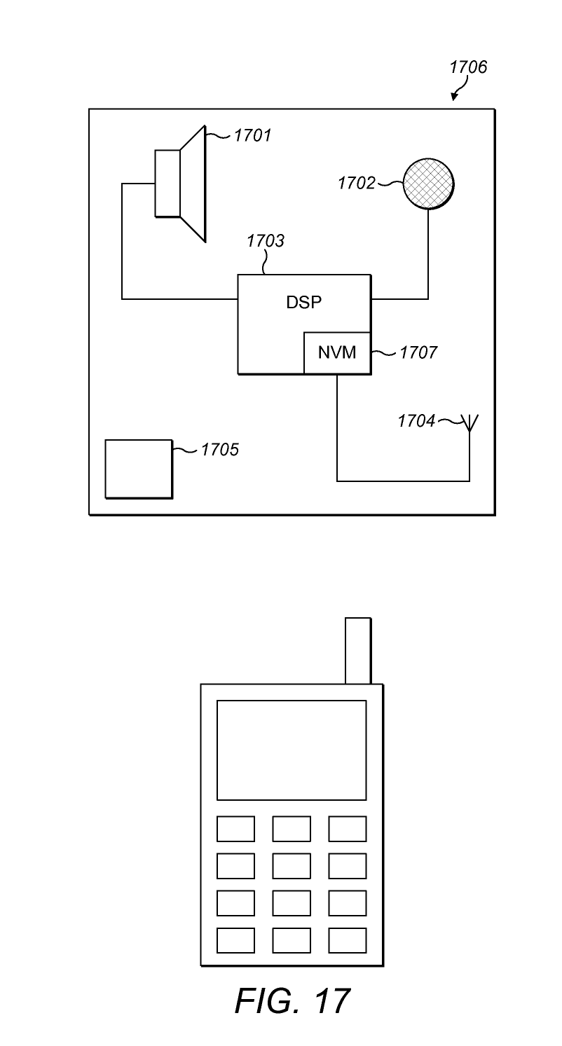

The approach described above could be used in systems such as wireless telephone headsets. As illustrated in FIG. 17, a typical wireless telephone headset comprises a speaker 1701 and a microphone 1702 which are connected to a digital signal processor (DSP) 1703. The digital signal processor is connected to a wireless transceiver 1704 by which it can communicate with a device such as a mobile phone. The device is powered by a battery 1705 and the components are housed in a case 1706. When the headset is in use, incoming voice data is relayed wirelessly to the wireless transceiver, which passes it to the DSP. The DSP processes the incoming data and drives the loudspeaker to generate an appropriate acoustic output. The voice of the user of the headset is picked up by the microphone and passed to the DSP. The DSP encodes that voice input and passes it to the wireless transceiver which transmits it. The DSP implements an adaptive ANC algorithm. Fixed coefficients for the ANC algorithm are stored in non-volatile memory 1707. The coefficients could be stored in the device at the time of manufacture—either manufacture of the DSP or of the headset. This allows the headset to benefit from the quality of an ANC algorithm without the computational overhead of calculating the ANC coefficients which could, for example, reduce battery life.

In practice, a manufacturer of headsets is likely to produce many thousands or millions of headsets, each of which will be identical. The preferred ANC coefficients for good cancellation of acoustic feedback from the loudspeaker to the microphone will be dependent on the acoustic properties of the headset—for example its shape, the distance between the loudspeaker and the microphone, the material of the inner casing and the relative orientation of the microphone and loudspeaker. In accordance with the approach described above, the ANC coefficients can be calculated before mass-production begins, independently of the existence of production headphones, using a sample of the headset with a loudspeaker and a microphone, or even using a computer simulation of the headset's acoustic properties. Once the coefficients have been pre-calculated in this way they can be stored and then programmed into every subsequently manufactured headset.

In practice, the DSP and the memory and optionally the wireless transceiver can be implemented on a single integrated circuit. The integrated circuit could be programmed with the coefficients for a particular device (e.g. the headset of FIG. 17) and subsequently installed in the device.

Once the DSP is installed in the device, it may be configured such that the coefficients cannot be changed. For example, the device may provide no user interface by which the coefficients can be altered, and may be configured not to alter the coefficients itself during operation.

The apparatus and methods disclosed herein provide a means of adaptively obtaining the coefficients for fixed controllers for use in an ANC system. The method and apparatus work independently of the ANC system. Once the impulse response of the plant of the system has been determined an adaptive algorithm is run in which the coefficients of a controller are adjusted to minimise an error signal. When the error signal has converged the values of the controller coefficients are taken as the values of the coefficients for the fixed controller. Once the coefficients have been determined, the values may be programmed on to a multitude of DSP chips allowing for a simple method of mass producing digital controllers for use in an ANC system. The method is independent of the ANC system because given any experimental data the response of the plant can be calculated, and given any experimental noise data the adaptive algorithm will compute corresponding optimum values of the controller coefficients to minimise an error signal. This advantageously allows for an ANC system to be designed subject to differing design requirements or for a given design of an ANC system to be optimised for use in differing noise environments.

What is claimed is:

1. A method for obtaining coefficients for a non-adaptive controller for use in an active noise control system, the method comprising
capturing experimental data from a target system to characterise the plant of the target system; and
implementing an adaptive algorithm to compute the coefficients in dependence on the experimental data.

2. A method as claimed in claim 1, wherein the operation of the controller comprises running a non-adaptive algorithm.

3. A method as claimed in claim 2, wherein the non-adaptive algorithm is pre-programmed.

4. A method as claimed in claim 1, wherein the value(s) of the coefficient(s) are programmable in the non-adaptive controller.

5. A method as claimed in claim 1, wherein the adaptive algorithm adjusts the value(s) of the coefficient(s) in order to minimise an error signal.

6. A method as claimed in claim 1, wherein the adaptive algorithm is implemented in sub-bands.

7. A method as claimed in claim 1, the method comprising obtaining coefficients for the controller for use in an active noise control system that is a feedforward, feedback or hybrid feedforward/feedback system.

8. A method as claimed in claim 1, wherein the adaptive algorithm obtains the coefficients automatically and independently of the system to be controlled.

9. A method as claimed in claim 1, wherein the adaptive algorithm is implemented prior to the operation of the non-adaptive controller.

10. A method as claimed in claim 1, comprising the steps of configuring the target system to simulate a production system and implementing in the production system an active noise control system having a non-adaptive controller using the computed coefficients.

11. An integrated circuit configured to implement a non-adaptive active noise control algorithm, the integrated circuit being configured to be externally programmable with one or more coefficients and to implement the active noise control algorithm in accordance with the coefficients.

12. A method of configuring an audio device, the audio device being integrated with a noise source and having a microphone and a loudspeaker and an integrated circuit that is capable of implementing a non-adaptive noise control algorithm to at least partially remove from an output signal of the microphone noise derived from the noise source, the method comprising:
testing a sample device having analogous audio properties to the said audio device to estimate the properties of the sample device;
determining in dependence on the estimated properties one or more coefficients for use in the non-adaptive noise control algorithm; and
storing those coefficients in the said audio device for use by it in implementing the non-adaptive noise control algorithm.

13. A method as claimed in claim 12, wherein the said determining step comprises implementing an adaptive noise control algorithm.

14. A method as claimed in claim 12, wherein the said determining step is performed using processing means other than the integrated circuit.
